(19) United States
(12) Patent Application Publication
(10) Pub. No.: US 2005/0174358 A1
(43) Pub. Date: Aug. 11, 2005

(54) Information palette

(76) Inventors: Ronald V. Baldwin II, Arlington, TX (US); John Howard, Keller, TX (US)

Correspondence Address: Thrasher Associates, LLC, 391 Sandhill Dr., Richardson, TX, 75080, US

(21) Appl. No.: 11/055,358

(22) Filed: Feb. 9, 2005

Related U.S. Application Data
(60) Provisional application No. 60/542,988, filed on Feb. 9, 2004.

(51) Int. Cl. G09G 5/02; G09G 5/00

(52) U.S. Cl. 345/581

(57) ABSTRACT

The invention teaches associating a first image comprising pixels with a first palette such that that the first image is viewable, whereby associating the image with a second palette results in a change to the first image that may or may not be viewable in a graphical information system. It is emphasized that this abstract is provided to comply with the rules requiring an abstract that will allow a searcher or other reader to quickly ascertain the subject matter of the technical disclosure. It is submitted with the understanding that it will not be used to interpret or limit the scope or meaning of the claims. 37 CFR 1.72(b).

### CROSS REFERENCE TO RELATED APPLICATIONS

The invention is related to and claims priority from U.S. Provisional Patent Application No. 60/542,988, filed on 9 Feb. 2004, by Scott, et al., and entitled IMAGE ENHANCEMENTS.

### TECHNICAL FIELD OF THE INVENTION

The invention relates to geographic information system (GIS) images.

### PROBLEM STATEMENT

Interpretation Considerations

This section describes the technical field in more detail, and discusses problems encountered in the technical field. This section does not describe prior art as defined for purposes of anticipation or obviousness under 35 U.S.C. section 102 or 35 U.S.C. section 103. Thus, nothing stated in the Problem Statement is to be construed as prior art.

### DISCUSSION

Pixel-based images represent image information by using a plurality of picture elements called pixels, arranged in a regular grid, each of which has a location expressed in X, Y (or pixel) coordinates, and an associated numeric value for color called a pixel value. Some common formats for pixel-based images include: tiff, png, and jpeg, for example. Some pixel-based image formats support “palletized” images, in which the pixel value is not itself a color, but rather, refers to a location in a lookup table, known as the palette, where the actual color value is recorded. Palletized images are normally used to allow a wider selection of colors than would otherwise be available for a specific number of bits per pixel. Additional advantages could be gained from a system that gives a user the ability assign, and then to hide or highlight selected attributes in an image.

### BRIEF DESCRIPTION OF THE DRAWINGS

Various aspects of the invention, as well as an embodiment, are better understood by reference to the following detailed description. To better understand the invention, the detailed description should be read in conjunction with the drawings in which:

FIG. 1 shows a simple flood map image.

FIG. 2 is a palette for a 2-bit pixel-based image.

FIG. 3 shows the numbering of the entries of a 5-bit palette, organized into 4 columns corresponding to pixel values from an original 2-bit image, and 8 rows corresponding to 8 possible attributes that may be encoded in the image using the remaining 3 bits per pixel.

FIG. 4a shows the palette of FIG. 3 with colors from the palette of FIG. 2 repeated in each row.

FIG. 4b shows the palette of FIG. 3 where each row has a single color value.

FIG. 4c show the palette of FIG. 3 where rows 2 and 5 contain colors that depend upon both the original image and the assigned attribute.

FIG. 5 is a block flow diagram of a palette information algorithm.

### EXEMPLARY EMBODIMENT OF A BEST MODE

Interpretation Considerations

When reading this section (An Exemplary Embodiment of a Best Mode, which describes an exemplary embodiment of the best mode of the invention, hereinafter “exemplary embodiment”), one should keep in mind several points. First, the following exemplary embodiment is what the inventor believes to be the best mode for practicing the invention at the time this patent was filed. Thus, since one of ordinary skill in the art may recognize from the following exemplary embodiment that substantially equivalent structures or substantially equivalent acts may be used to achieve the same results in exactly the same way, or to achieve the same results in a not dissimilar way, the following exemplary embodiment should not be interpreted as limiting the invention to one embodiment.

Likewise, individual aspects (sometimes called species) of the invention are provided as examples, and, accordingly, one of ordinary skill in the art may recognize from a following exemplary structure (or a following exemplary act) that a substantially equivalent structure or substantially equivalent act may be used to either achieve the same results in substantially the same way, or to achieve the same results in a not dissimilar way.

Accordingly, the discussion of a species (or a specific item) invokes the genus (the class of items) to which that species belongs as well as related species in that genus. Likewise, the recitation of a genus invokes the species known in the art. Furthermore, it is recognized that as technology develops, a number of additional alternatives to achieve an aspect of the invention may arise. Such advances are hereby incorporated within their respective genus, and should be recognized as being functionally equivalent or structurally equivalent to the aspect shown or described.

Second, the only essential aspects of the invention are identified by the claims. Thus, aspects of the invention, including elements, acts, functions, and relationships (shown or described) should not be interpreted as being essential unless they are explicitly described and identified as being essential. Third, a function or an act should be interpreted as incorporating all modes of doing that function or act, unless otherwise explicitly stated (for example, one recognizes that “tacking” may be done by nailing, stapling, gluing, hot gunning, riveting, etc., and so a use of the word tacking invokes stapling, gluing, etc., and all other modes of that word and similar words, such as “attaching”).

Fourth, unless explicitly stated otherwise, conjunctive words (such as “or”, “and”, “including”, or “comprising” for example) should be interpreted in the inclusive, not the exclusive, sense. Fifth, the words “means” and “step” are provided to facilitate the reader's understanding of the invention and do not mean “means” or “step” as defined in §112, paragraph 6 of 35 U.S.C., unless used as “means for -functioning-” or “step for -functioning-” in the Claims section. Sixth, the invention is also described in view of the Festo decisions, and, in that regard, the claims and the invention incorporate equivalents known, unknown, foreseeable, and unforeseeable. Seventh, the language and each word used in the invention should be given the ordinary interpretation of the language and the word, unless indicated otherwise.

Some methods of the invention may be practiced by placing the invention on a computer-readable medium. Computer-readable mediums include passive data storage, such as a random access memory (RAM) as well as semi-permanent data storage such as a compact disk read only memory (CD-ROM). In addition, the invention may be embodied in the RAM of a computer and effectively transform a standard computer into a new specific computing machine.

Data elements are organizations of data. One data element could be a simple electric signal placed on a data cable. One common and more sophisticated data element is called a packet. Other data elements could include packets with additional headers/footers/flags. Data signals comprise data, and are carried across transmission mediums and store and transport various data structures, and, thus, may be used to transport the invention. It should be noted in the following discussion that acts with like names are performed in like manners, unless otherwise stated.

Of course, the foregoing discussions and definitions are provided for clarification purposes and are not limiting. Words and phrases are to be given their ordinary plain meaning unless indicated otherwise.

### DESCRIPTION OF THE DRAWINGS

Pixel-based images are limited to representing color information, and assign no underlying meaning to pixels that might represent features in the image. For example, an image derived from an aerial photograph might depict two adjoining fields, one with a crop of corn, and another with soybeans. Visually, it may be difficult to distinguish between the two crops. The ability to assign a crop-type attribute to each pixel of the image, and to control the display of that attribute, would overcome this shortcoming. The methodology to do this will be readily apparent upon reading the below description, which specifically discusses how to attribute information to pixels in flood maps.

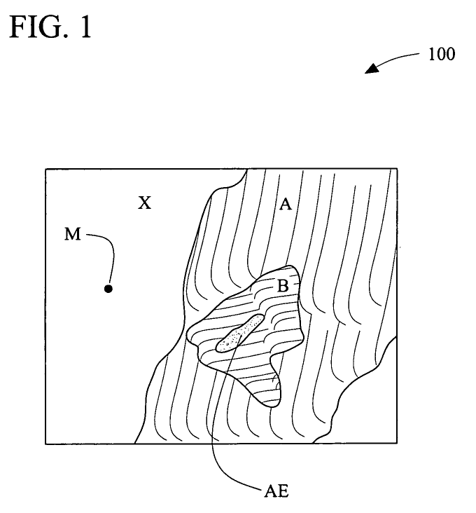

FIG. 1 shows a simple flood map image (the image) 100. Flood map images are well known, and available from FEMA, among other sources. The image 100 comprises a first flood zone A that is generally recognized as a 100-year flood plain having generally vertical striping, while a second flood zone B generally defines a 500-year flood plain identifiable by generally horizontal striping. Similarly, a third flood zone AE defines area recognizable as another type of 100 year flood zone, and is recognizable as being a region of stipples. The image also maintains a pixel, M, located outside the flood zones A-AE, in flood zone X.

In general, a pixel is as close to a specific point as one can get on an image, and the concept and technology of digital pixels are well known in the digital display arts. Those of ordinary skill in the art will readily recognize that a pixel is generally definable as a location (typically an “X,Y” coordinate) and a color that may also include other display information, as known in the image arts. Accordingly, in these cases, a pixel is defined by its X,Y location and its numeric value defining color.

In imaging systems, it is known that “best” images are displayed in “true color” or “high color” formats, which may maintain 24, 32, or more bits of color information. This means that 24 or 32 bit color formats can display, potentially, literally millions or even billions of colors. Of course, the present invention is not limited to any particular color system, as its teachings are readily adaptable by those of skill in imaging arts to other imaging systems upon reading the present disclosure.

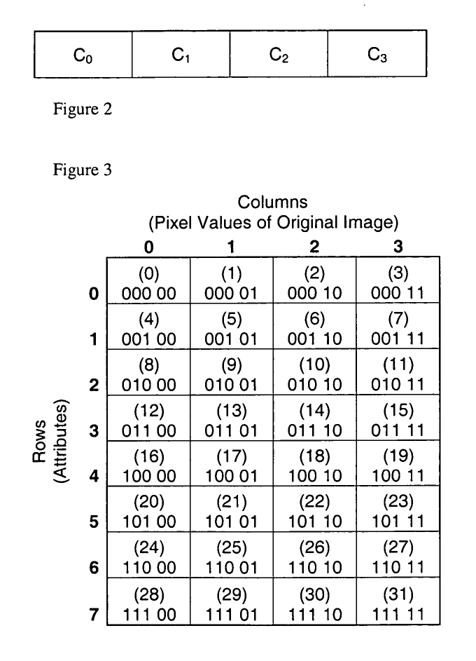

FIGS. 2 through 4 represent palettes. A palette is, from one point of view, a transform that in one embodiment uses limited sets of information to allow an image comprising only a few colors to be expressed using any of the colors available in a higher-quality color format (note that the use of the term “color” herein includes gray scale images, unless otherwise indicated). Accordingly, a palette contains multiple entries, each of which corresponds to one of potentially billions of colors supported in the underlying operating system. Thus, pixels reference palette entries, which in turn reference colors in the underlying operating system.

For example, if an image uses only four colors, it may have a palette comprising only four entries, and each pixel in the image need only reserve two bits for color information, rather than the 24 or 36 bits indicated above. As a result, for images that need only a limited number of colors, palettizing increases the memory efficiency of images. Thus, from one point of view, a palette is a form of image compression. This system is used, for example, to increase the display speed in some imaging systems.

FIG. 2 is a palette for a 2-bit pixel-based image. To define a color of a pixel using a palette, the pixel provides a reference into the palette. In a hypothetical 2-bit color system, shown in FIG. 2 and referring also to FIG. 1, a pixel M (x, y, 01) expresses the color corresponding to palette entry (01), by merely referencing a color defined in the underlying operating system that has been predefined in the palette (or, in other words, “mapping” from the operating system color defined in that palette position to the pixel). The color C₂ is predefined in the palette, and may be any color displayable by the underlying operating system. Accordingly, the pixel references to palette position (01) (or decimal 1), which in turn calls color C₁ from the underlying operating system, and thus the pixel displays (in that pixel's location) color C₁. Thus, from one point of view, defining the color in the palette defines the pixel color by reference.

An “attribute” is information associated with a location. For example, attributes known in the flood zone data arts, may include flood zone classification, map panel number, community, community participation status, and any other kind of data. The invention is not limited to any particular type of attribute data as the application of attributes will be readily apparent to those of ordinary skill in the art upon reading the disclosure.

Described herein is a novel use of palletized images, wherein attribute information is stored in the image using extra bits added to, or unreserved in, each pixel of the original image. Start with a first (original) image having m-bits per pixel. Then, create a second, palletized, image with m+n bits per pixel. The information in the m-bits of the first image is preserved in the second image, and attribute information about each pixel is encoded in the additional n-bits of the second image. Next, assign colors to a palette so that the second image, when displayed, provides some desired visual representation of the information encoded in the m+n bits of the pixels. The figures described below deal specifically with the special case of m=2, and n=3, but one skilled in the art will readily understand the generalization of the descriptions to any other values of m or n.

FIG. 3 shows the numbering of the entries of a 5-bit palette, organized into 4 columns corresponding to pixel values from an original 2-bit image, and 8 rows corresponding to 8 possible attributes that may be encoded in the image using the remaining 3 bits per pixel. Imagine that FIG. 1 represents an original, 2-bit (2-bits per pixel) image, having the palette shown in FIG. 2, which is augmented to a 5-bit palletized image by the addition of 3-bits of attribution data per pixel. The new value assigned to each pixel is a concatenation, or linking, of the 3-bit attribution value together with the original 2-bit pixel value. The palette of the new 5-bit image contains 32 elements that are organized, as shown in FIG. 3, into eight rows corresponding to each of the eight attributions possible with 3-bits, and four columns corresponding to each of the four possible colors of the original image. For example, a pixel whose new attribution value is binary 101 (decimal 5) and whose original value is binary 10 (decimal 2), will have a pixel value of 10110 (decimal 22). Notice that palette element 22 lies in the row 5 and column 2 entry, as expected. For a flood map image, such as image 100, attributes recorded in the augmented image might well correspond to different flood zone classification values.

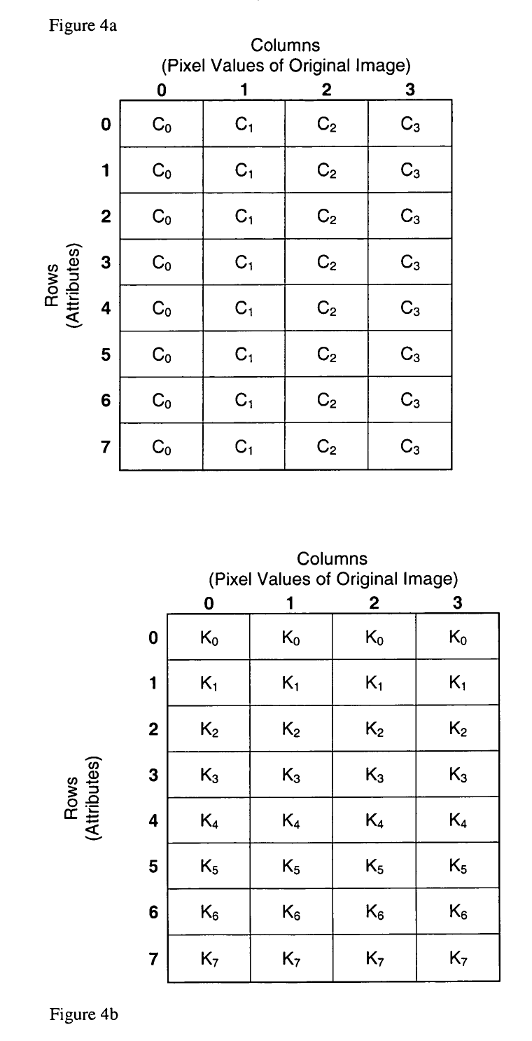

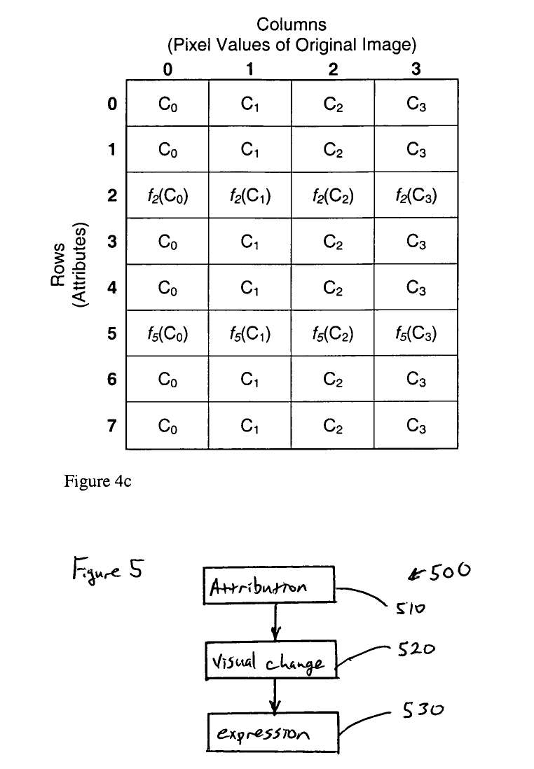

FIG. 4a shows the palette of FIG. 3 with colors from the palette of FIG. 2 repeated in each row. FIG. 4a illustrates how the colors of the new palette can be assigned in such a way that the new 5-bit image will be identical in appearance to the original 2-bit image. This is accomplished by assigning the colors of the palette so that all pixels sharing the same 2-bits of image information from the first image have identical colors regardless of the values of the additional 3-bits of attribution information. This, in effect “hides” the attribution data.

FIG. 4b shows the palette of FIG. 3 where each row has a single color value. FIG. 4b illustrates how the colors of the new palette can be assigned in such a way that pixels of the new 5-bit image that share the same 3-bit attribution value will all be displayed in the same color, irrespective of their 2-bit original image value. This is accomplished by assigning the colors of the palette so that all pixels sharing the same 3-bits of additional attribution data have identical colors. This, in effect allows viewers to focus on attribution without being distracted by original image features.

FIG. 4c illustrates how the colors of the new palette can be assigned in such a way that pixels having attribution values of 2 or 5 are assigned colors that depend, in general, on both the pixel values of the original image, as well as the attribution values. For example, the original 2-bit pixel value might determine the saturation and brightness of the new palette entry, while the 3-bit attribution value might determine the hue of the new palette entry. This, in effect, allows the user to variously highlight pixels having attributes 2 and 5 while continuing to view information from the original 2-bit image for those pixels.

It will be readily understood by one skilled in the art, that there are many possible ways in which the m-bits from the original image may be combined with the n-bits of new attribution data. The method of combination described herein lends itself to easy description, but it should be understood that the applicability of this invention is not bound to any particular method of combination. More specifically, we may combine the m-bit and n-bit values using any one-to-one function, f, which maps m-bit/n-bit pairs to m+n bit pixel values of the palletized image. The use of “non-obvious” functions, f, obscures the attribution information, by effectively “scrambling” the palette, and thus amount to a form of encryption. Therefore, encryption is applicable to the teachings of the invention.

FIG. 5 is a block flow diagram of a palette information algorithm 500. The algorithm 500 begins in an attribution act 510 in where pixels in an image may be associated with attributes and/or colors, where a color may also be associated with an attribute. Attribution data is encoded into a palletized image, in the case of the example above, by changing the 3 attribution bits of the pixel to the appropriate row, while leaving the original 2-bits of the columns unchanged. The attribution of pixels can be accomplished using a Graphical User Interface (GUI), wherein the user selects regions of pixels and assigns an attribute to each selected region. The colors of attributed regions can be rapidly toggled, highlighting boundaries between regions, revealing potential errors. This results in a highly effective and accurate means of attribution. Once an image is attributed, it is a simple matter to extract attributed polygons, which may be used in most standard GIS applications.

The image is then associated with a palette. The palette is predefined to display information associated with that image via a GUI or any other manner known in the visual display arts. Next, in a visual change act 520 the algorithm 500 receives an indication that the image is to reference a new palette. The new palette is predefined to allow an attribute value not viewable in the first palette to be viewed, and/or to hide an attribute value that is viewable in the base palette. The attribute value is then displayed (or hidden, as the case may be) via the image alteration, in an attribute value expression act 530.

Once encoded with attribute information, an image can be manipulated by selectively modifying palette color values in rows and/or columns, as exemplified above, or in any other similar fashion. From an external perspective, this has the visual effect of instantly changing the display of the image. Attributes or features of the original image can be highlighted, de-emphasized, or completely hidden. For example, the display of a palletized image derived from FIG. 1 might be programmatically manipulated to display all pixels sharing the flood zone, currently under the mouse pointer, in a shade of red, having the visual effect of instantly tracking the mouse pointer. Additionally, the attribution data itself can be displayed in a region elsewhere on the screen.

As discussed, attribution data is encoded into a palletized image, in the case of the example above, by changing the 3 attribution bits of the pixel to the appropriate row, while leaving the original 2-bits of the columns unchanged. The attribution of pixels can be accomplished using a Graphical User Interface, wherein the user selects regions of pixels and assigns an attribute to each selected region. The colors of attributed regions can be rapidly toggled, highlighting boundaries between regions, revealing potential errors. This results in a highly effective and accurate means of attribution. Once an image is attributed, it is a simple matter to extract attributed polygons, which may be used in most standard GIS applications.

Thus, it has been shown that ascribing various attributes in an image to palettes allows a user to quickly alter the visual display of pixel-based images, and gives pixel-based images functionality formerly associated only with vector images. It has also been shown that a feature may be highlighted or de-emphasized, or even hidden by altering the color palette in a variety of ways, such as making the image change appear to be an “instantaneous” visual change, such as through the use of software, via a virtual scroll bar or the like. Likewise, it is apparent that multiple images may actually be stored in one pixel-based image file, which may then be displayed individually or jointly. Further, it is apparent that attributed polygons are easily extracted from encoded pixel-based images for use in any standard GIS application. Thus, the invention may be used to efficiently generate, in a less error prone way, attributed polygon data.

Of course, it should be understood that the order of the acts of the algorithms discussed herein may be accomplished in different order depending on the preferences of those skilled in the art, and such acts may be accomplished as software. Furthermore, though the invention has been described with respect to a specific preferred embodiment, many variations and modifications will become apparent to those skilled in the art upon reading the present application. It is therefore the intention that the appended claims and their equivalents be interpreted as broadly as possible in view of the prior art to include all such variations and modifications.

1. In a computer system, a system for storing and displaying attribute and image information in a palettized pixel-based image comprising:
a first image comprising a plurality of pixels, wherein each pixel value is m-bits in size, the m-bits designated as image information;
each pixel of the first image is assigned an attribute value expressed in n-bits per pixel, the n-bits designated as attribute information;
a second palletized image created from the first image and the attribute assignments, the second image comprising a plurality of pixels, wherein each pixel value is m+n bits in size; and
for each pixel in the first image corresponding to a pixel in the second image, the first image pixel value and attribute value are stored in the corresponding second image pixel value.

2. The method of claim 1 further comprising assigning a color to each entry of the second image palette, so that the second image, when displayed provides some desired visual representation of the information encoded in the m+n bits of its pixels.

3. The method of claim 2 wherein colors are assigned to the palette such that pixels sharing the same m-bits of image information from the first image have identical colors independent of the values of the additional n-bits of attribution information.

4. The method of claim 3 wherein the colors of the palette are assigned such that the palletized image, when displayed, is visually identical to the first image.

5. The method of claim 2 wherein colors of the palette are assigned such that all pixels sharing the same n-bits of attribution information have identical colors, regardless of the values of the original m-bits pixel values.

6. The method of claim 2 wherein color is assigned to the palette such that a color of each pixel comprises
characteristics that are affected by the values of the m-bits from the image information, and
characteristics that are affected by the values of the n-bits from the attribution information, such that
the palletized image shows features that are a combination of image information and attribution information from both the first image pixel values and the attribution values.

7. The method of claim 6 wherein the display characteristics include one of: saturation, hue, or brightness.

8. The method of claim 1 wherein the attribution information corresponds to the pixel values of a second image.

9. The method of claim 1 wherein the first image is a flood map.

10. The method of claim 1 wherein the image is scanned raster image.

11. The method of claim 1 wherein the attribute values are flood zone classifications.

12. The method of claim 1 wherein the image is a grayscale image.

13. The method of claim 1 wherein the image is a Federal Emergency Management Agency flood map.

14. The method of claim 2 wherein a color assigned to a palette is “no color.”

15. A method of associating attribution information with a displayed image, comprising:
receiving an image comprising a plurality of pixels to define a pixel-based image;
the pixels comprising a horizontal location datum, a vertical location datum, and a palette reference datum;
a palette comprising a plurality of palette entries;
each palette entry comprising a set of bits;
a first palette reference datum associated with a first palette entry, the first palette entry comprising a first set of bits; and
the first set of bits comprising bits that identify an attribute, the attribute expressible in the image as a color available in an operating system.

16. The method of claim 15 wherein the attribute is a flood zone.

17. The method of claim 15 wherein the color is “no color.”

18. The method of claim 1 wherein the attribution information may be extracted from the second palletized image in the form of a set of polygons with assigned attributions.

19. The method of claim 18 wherein the extracted polygons may be utilized in a Geographic Information System.
